(19) United States
(12) Patent Application Publication
(10) Pub. No.: US 2003/0189878 A1
(43) Pub. Date: Oct. 9, 2003

(54) Magneto-optical recording medium having magnetic film formed by sputtering and method of producing same

(76) Inventor: Toshimori Miyakoshi, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/403,295

(22) Filed: Apr. 1, 2003

(30) Foreign Application Priority Data
Apr. 9, 2002 (JP) 106141/2002

(51) Int. Cl. G11B 11/00

(52) U.S. Cl. 369/13.45; 369/13.41; 369/13.47; 369/13.46

(57) ABSTRACT

At least a reproduction layer of a magneto-optical recording medium is formed by sputtering using a processing gas comprising Kr or Xe as a main component. Hence, it is possible to reduce the dependence of saturation magnetization M_{S} on temperature, thereby decreasing the influence of a demagnetizing field and a floating magnetic field over a wide range of temperature.

### BACKGROUND OF THE INVENTION

1. Field of the Invention

The present invention relates to a magnetooptical recording medium for ultrahigh-density recording and a method of producing the same.

2. Related Background Art

Various magnetic recording mediums have been put into practical use as rewritable recording mediums. Particularly magneto-optical recording mediums have been promising as large-capacity commutative mediums capable of high-density recording. The magneto-optical recording medium writes a magnetic domain in a magnetic thin film by using thermal energy of a semiconductor laser to record information and reads the information by using a magneto-optical effect. In recent years, according to the trend of digitization of moving images, there has been an increasing demand to increase recording densities of these magnetic recording mediums to obtain recording mediums with larger capacities.

In general, a linear recording density of a magneto-optical recording medium largely depends upon a laser wavelength of a reproducing optical system and a numerical aperture NA of an objective lens. Namely, when a laser wavelength λ of the reproducing optical system and a numerical aperture NA of the objective lens are determined, a beam waist diameter is also determined. Thus, a spatial frequency of a recording pit capable of reproducing a signal is limited up to about 2NA/λ. Therefore, in order to achieve a high density on a conventional optical disk, it is necessary to shorten a laser wavelength of a reproducing optical system or increase a numerical aperture of an objective lens. However, it is not easy to shorten a laser wavelength in view of efficiency of elements, heat generation, and so on. Further, when an objective lens is increased in numerical aperture, a higher mechanical accuracy is demanded due to decrease of a depth of focus and so on. For this reason, the so-called super-resolution techniques have been developed in various forms to improve a recording density by devising the configuration and the reproducing method of a recording medium regardless of a laser wavelength and a numerical aperture of an objective lens.

For example, Japanese Patent Application Laid-Open Nos. 3-93058 and 6-124500 propose a signal reproducing method in which after a signal is recorded in a record holding layer of a multilayer film, which has a reproduction layer and a record retention layer magnetically coupled with each other, and the direction of magnetization of the reproduction layer is aligned (the direction of magnetization is in-plane in Japanese Patent Application Laid-Open No. 6-124500), a laser light is emitted for heating, and a signal recorded in the record holding layer is read while being transferred to a temperature raising area of the reproduction layer. In this method, an area (aperture), which is heated by the laser to reach a transferring temperature and has a signal detected, is limited to a smaller area with respect to a spot diameter of a reproducing laser. Thus, intersymbol interference is reduced during reproduction and it is possible to reproduce a signal having a pit period with an optical detection limit of λ/2NA or less. This reproducing method is called an MSR (Magnetically-induced Super resolution Readout method) reproducing method.

However, in the MSR reproducing method, an effectively used signal detection area is small relative to a spot diameter of reproduction laser. Hence, the amplitude of a reproduction signal is greatly reduced and a sufficient reproduction output cannot be obtained. Thus, the effective signal detection area cannot be so small relative to the spot diameter and thus a quite high density cannot be achieved with respect to a recording density determined by the diffraction limit of an optical system.

Japanese Patent Application Laid-Open No. 6-290496 proposes a magneto-optical recording medium and reproducing method in which a magnetic domain wall (hereinafter, simply referred to as “domain wall”) existing at a boundary portion of a recording mark is let to move to a high-temperature side according to a temperature gradient, and the displacement of the domain wall is detected, so that a signal with a recording density exceeding a resolution of an optical system can be reproduced without reducing the amplitude of a reproduction signal. This reproducing method is called a DWDD (Domain Wall Displacement Detection) reproducing method.

The DWDD reproducing method utilizes a first magnetic layer having small domain wall coercive force, a second magnetic layer having a low Curie temperature, and a third magnetic layer having large domain wall coercive force. As described in a literature of J. Magn. Soc. Jpn., 22, suppl. No. S2, pp. 47-57 (1998), the first magnetic layer serves as a displacement (reproduction) layer where a domain wall moves during reproduction, the second magnetic layer serves as a switching layer for controlling a starting position of the movement of a domain wall, and a third magnetic layer serves as a memory (recording) layer for retaining an information. When a temperature distribution is formed on the surfaces of these magnetic films, a distribution of domain wall energy is formed accordingly and a domain wall driving force is generated so as to move a domain wall to a high-temperature side having a low energy. However, magnetic layers are coupled exchangeably with each other in an area lower in temperature than a Curie temperature of the switching layer. Thus, even when the above domain wall driving force is applied, the driving force is interrupted by a large domain wall coercive force of the memory layer, so that the domain wall will not move. However, since an exchangeable coupling force is reduced at a position at a temperature near to the Curie temperature (Tc) of the switching layer, only a domain wall in the displacement layer, which has a small domain wall coercive force, moves separately to the high-temperature side. The domain wall moves at a time interval corresponding to a special interval of the domain wall when a medium is moved relative to a temperature distribution. Therefore, by detecting generation-of displacement of the domain wall, a signal can be reproduced regardless of a resolution of an optical system.

The above explanation described the behavior of a domain wall only based on the relationship among a domain wall driving force generated by a gradient of domain wall energy, a friction force generated by a domain wall coercive force, and a force generated by exchange interaction between magnetic layers. Actually, the domain wall is affected by a demagnetizing field and a floating magnetic field. Further, when a magnetic domain is surrounded while being closed, the magnetic domain appears and disappears depending upon whether a domain wall moves in a domain wall expanding direction or reducing direction, thereby affecting the behavior of the domain wall. However, discussions have been made until now on the assumption that the influence of a demagnetizing field and a floating magnetic field and the influence of a domain wall formed on the side of a recording mark are reduced to a negligible level by adjusting a medium.

The influence of generation/disappearance of a domain wall can be eliminated by separately forming domain walls around a recording mark. For example, on both sides of a recording track, when a medium is used in which the coupling made by exchangeable interaction in the film surface direction of a magnetic film is interrupted or reduced, the above-described problem can be solved.

On the other hand, the influence of a demagnetizing field and a floating field can be suppressed by reducing saturation magnetization. For example, the composition is normally adjusted such that a reproduction layer has a magnetically compensated temperature around the Curie temperature of a switching layer serving as a reproducing temperature, thereby reducing the saturation magnetization, so that the problem should be solved.

However, in the case of reproduction, since it is necessary to detect a change in a plane of polarization of a light reflected from a reproduction layer, there is another demand to sufficiently develop a magnetic moment around the Curie temperature of the switching layer that serves as a reproducing temperature. Therefore, a temperature of the spot emitting area of a reproducing light beam (that is, reproducing temperature) has to be sufficiently lower than the Curie temperature of the reproduction layer. Thus, the Curie temperature of the reproduction layer has to be sufficiently higher than a magnetically compensated temperature serving as a reproducing temperature (however, it is more preferable to set the upper limit at a temperature less than the Curie temperature of a recording layer so that recording is not affected). Hence, as to the reproduction layer, the Curie temperature and the magnetically compensated temperature are quite far from each other (one hundred and several tens ° C.), so that the saturation magnetization of the reproduction layer tends to greatly depend upon a temperature. Thus, a distribution of saturation magnetization is likely to appear in the spot emitting area of a reproducing light beam. As a result, it is not possible to avoid the influence of a demagnetizing field and a floating magnetic field, resulting in an unstable reproducing operation.

Further, when a track pitch is reduced to improve an areal density, the above-described problems clearly arise and it is not possible to ignore the influence of an adjacent track and the like on a dynamic property such as cross talk.

### SUMMARY OF THE INVENTION

It is, therefore, an object of the present invention to provide a magneto-optical recording medium and a method of producing the same that reduce the dependence of saturation magnetization of a reproduction layer on temperature to decrease the influence of a demagnetizing field and a floating magnetic field.

In order to attain the above object, in the present invention, at least a reproduction layer is formed by sputtering using a processing gas comprising Kr or Xe as a main component. Hence, it is possible to reduce the dependence of saturation magnetization M_{S} on temperature. As a result, it is possible to decrease the influence of a demagnetizing field and a floating magnetic field over a wide range of temperature, achieve a stable reproducing operation, and decrease the influence of crosstalk even-when a track pitch is reduced.

### BRIEF DESCRIPTION OF THE DRAWINGS

FIG. 1 is a diagram showing the layer structure of a magneto-optical recording medium according to one embodiment of the present invention;

FIG. 2A is a graphical representation showing the dependence of saturation magnetization M_{S} of a reproduction layer on temperature according to an example of the present invention; and

FIG. 2B is a graphical representation showing the dependence of saturation magnetization M_{S} of a reproduction layer on temperature according to a comparative example of the present invention.

### DESCRIPTION OF THE PREFERRED EMBODIMENTS

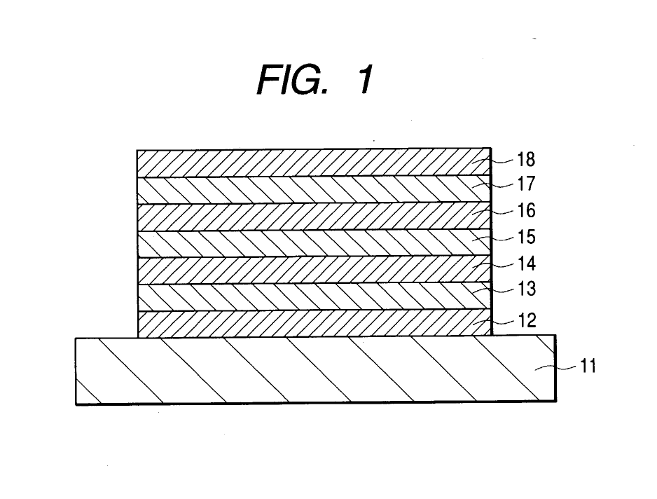

An embodiment of the present invention will be described with reference to the accompanied drawings. Referring to FIG. 1, a magneto-optical recording medium according to the embodiment of the present invention is constituted by a first dielectric layer 12, a reproduction layer 13, a control layer 14, a switching layer 15, a recording layer 16, an auxiliary recording layer 17, and a second dielectric layer 18 which are sequentially stacked on a substrate 11.

For example, the substrate 11 is a substrate made of a material such as polycarbonate, acrylic resin, and glass. For example, the first dielectric layer 12 and the second dielectric layer 18 are thin films made of a material such as SiN, AlN, SiO, ZnS, MgF, and TaO. Further, when the movement of a domain wall is not optically detected, a transparent material is not always necessary.

The reproduction layer 13, the switching layer 15, and the recording layer 16 are three layers which are indispensable for a DWDD operation. The reproduction layer 13 has the function of allowing a domain wall to move in order to expand a recording magnetic domain during reproduction and has a smaller domain wall coercive force than those of the switching layer 15 and the recording layer 16. Moreover, the switching layer 15 has the function of breaking an exchangeable coupling between the reproduction layer and the recording layer during reproduction and has a lower Curie temperature than the Curie temperatures of the reproduction layer 13 and the recording layer 16. The control layer 14 is to restrict unnecessary movement of a domain wall (ghost signal) on the rear end in a reproduction beam spot, and may be a magnetic layer made of a TbFeCo or TbDyFeCo type material. The auxiliary recording layer 17 is to make an adjustment for increasing the sensitivity to a modulation magnetic field during recording, and may be a magnetic film made of a GdFeCo or GdDyFeCo type material.

In the above configuration, an auxiliary reproduction layer which is lower in Curie temperature than the reproduction layer may be provided so as to be adjacent to the opposite side of the incident side of a light beam to improve the domain wall driving force. Further, a metal layer made of a material such as Al, AlTa, AlTi, AlCr, AlSi, Cu, Pt, and Au may be added to adjust a thermal characteristic. Moreover, a protective coating made of a polymeric resin may be applied or a substrate having films formed thereon may be bonded. Also, a layer other than the magnetic layers is not always necessary, and the order of stacking the magnetic layers may be reversed. Furthermore, the interfaces of the magnetic layers do not always have to be clear and steep, and the composition may gradually vary in the thickness direction.

These layers can be deposited and formed by continuous sputtering, continuous vapor deposition, and the like using a magnetron sputtering apparatus or the like. Particularly, the magnetic layers are coupled exchangeably with each other by continuous film formation without breaking a vacuum state.

In the above medium, the magnetic layers 13 may be made of various magnetic materials such as a magnetic bubble material and an antiferromagnetic material in addition to materials generally used for magnetic recording mediums and magneto-optical recording mediums. For example, the magnetic layers may be made of a rare earth-iron group element amorphous alloy, which is composed of 10-40 atomic % of one or more kinds of rare-earth metal elements such as Pr, Nd, Sm, Eu, Gd, Tb, Dy, Ho, and Er and 90-60 atomic % of one or more kinds of iron group elements such as Fe, Co, and Ni. Further, in order to improve corrosion resistance and so on, a small amount of elements such as Cr, Mn, Cu, Ti, Al, Si, Pt, and In may be added to these alloys. Besides, the following materials may be used: a platinum group-iron group periodic structural film made of a material such as Pt/Co and Pd/Co, a platinum group-iron group alloy film, a demagnetizing material such as Co—Ni—O and a Fe—Rh alloy, a magnetic garnet, and so on.

In the case of a heavy rare earth-iron group element amorphous alloy, the saturation magnetization can be controlled according to a compositional ratio of a rare-earth element and an iron group element. In the case of a compensated composition, the saturation magnetization can also be set at Oemu/cc at room temperature.

The Curie temperature can also be controlled according to a compositional ratio. In order to perform control independently of saturation magnetization, a method is available in which a material having Fe partially substituted by Co is used as an iron group element to control a substitution ratio. Namely, since a rise in Curie temperature of about 6° C. is expected to by substituting Co for Fe element by 1 atomic %, an addition amount of Co can be adjusted using this relation to attain a desired Curie temperature. Otherwise, the Curie temperature can be lowered by adding a slight amount of a non-magnetic element such as Cr, Ti, and Al. Further, the Curie temperature can also be controlled by using two or more kinds of rare-earth elements in combination and adjusting the compositional ratio thereof.

The domain wall coercive force and the domain wall energy density are mainly controlled by selecting source material elements but can also be adjusted by the state of the underlying first dielectric layer, the film-forming conditions such as a sputtering gas pressure, and so on. Tb and Dy materials are large in anisotropy, domain wall coercive force, and domain wall energy density, and Gd materials are small therein. These physical property values can also be controlled by adding an impurity and so on. The film thickness can be controlled according to a film-forming speed and film-forming time.

Incidentally, a plurality of recording tracks are formed on the medium, and the coupling resulting from exchangeable interaction in the film surface direction of the magnetic film is broken or reduced on both sides of the recording track by annealing or removal/defect of the magnetic film.

In the present invention, a data signal is recorded in the magneto-optical recording medium by matching a magnetic alignment state of the recording layer with the data signal by using magnetic recording or thermomagnetic recording. The thermomagnetic recording includes a method of modulating an external magnetic field while emitting a laser beam with such a power as to raise the temperature of the recording layer to the Curie temperature or more during movement of the medium, and a method of modulating a laser power while applying a magnetic field in a fixed direction. In the latter case, when the intensity of a laser beam is adjusted such that only a predetermined area in a light spot rises to the Curie temperature of the recording layer or more, a recording magnetic domain can be formed with a diameter smaller than the light spot, and thus it is possible to form a recording pattern with a higher density than the resolution of an optical system.

The following will discuss a specific example of the present invention.

### EXAMPLE

After a target of each of Si doped with B, Gd, Tb, FeCr, and CoCr was mounted on a DC magnetron sputtering apparatus, and a polycarbonate substrate having a guide groove for tracking formed therein was fixed to a substrate holder, the inside of a chamber was evacuated by a cryopump until a high vacuum of 2×10⁻⁵ Pa or less was attained. Thereafter, Ar gas or Kr gas was introduced into the chamber while evacuation was performed, and the targets were sputtered to form layers while the substrate was rotated. When a SiN layer was formed, N₂ gas was introduced in addition to Ar gas, so that DC reactive sputtering was performed to form the layer.

First, Ar gas and N₂ gas were flown into the chamber, the inner pressure was set at a desired value by conductance adjustment, and a SiN layer of 35 nm in thickness was formed as the first dielectric layer.

When forming the magnetic films, because contamination with N₂ gas resulted in nitridation or the like to affect the magnetic characteristic, the dielectric layers and the other magnetic layers were formed in separate chambers. After the first dielectric layer was formed, the substrate was transported to another chamber, Kr gas was introduced at 18 sccm thereinto, a desired pressure of about 0.8 Pa was attained by conductance adjustment, and a GdFeCoCr layer with a thickness of 36 nm was formed as the reproduction layer.

Prior to the formation of the magnetic layers subsequent to the reproduction layer, the introduction of Kr gas was suspended and the inside of the chamber was evacuated to a certain degree. Then, Ar gas was introduced at 50 sccm, the inner pressure was set at about 1.0 Pa by conductance adjustment, and the subsequent magnetic layers were formed. A TbFeCoCr layer with a thickness of 18 nm was formed as the control layer, a TbFeCr layer with a thickness of 10 nm was formed as the switching layer, and TbFeCoCr layer was formed as the recording layer with a thickness of 60 nm. Thereafter, a GdFeCoCr layer with a thickness of 20 nm was formed as the auxiliary recording layer.

Finally, as with the formation of the first dielectric layer, a SiN layer with a thickness of 50 nm was formed as the second dielectric layer by DC reactive sputtering.

As to the magnetic layers, the compositional ratios were controlled according to a ratio of powers applied to the targets of Gd, Tb, FeCr, and CoCr. The compositional ratios were adjusted so that each of the magnetic layers has a composition close to the compensated composition. To be exact, adjustment was performed to make the rare-earth element somewhat dominant at room temperature so that the rare-earth elements and the iron group elements were compensated at temperatures near to the Curie temperature of the switching layer serving as a reproduction temperature. Specifically, the Curie temperature of the reproduction layer was adjusted to about 290° C., the Curie temperature of the control layer was set at about 170° C., the Curie temperature of the switching layer was set at about 160° C., the Curie temperature of the recording layer was set at about 330° C., and the Curie temperature of the auxiliary recording layer was set at about 380° C.

The dynamic characteristic of the sample thus prepared was evaluated by using a magneto-optical disk evaluating device which has a magnetic head conventionally used for magnetic field modulation recording with a laser wavelength of 680 nm and an objective lens of N.A. 0.55. Recording was performed as follows: by modulating a magnetic field at about ±200 Oe while performing direct-current emission of laser, the patterns of an upwardly magnetized area and a downwardly magnetized area that correspond to the modulation of the magnetic field are transferred from the auxiliary recording layer in a cooling process after the recording layer was heated to the Curie temperature or more.

First, a tracking servo was driven on the guide groove of the medium before the recording, and while the medium was driven at a linear velocity of 3.0 m/sec, a laser beam condensed for recording/reproduction was continuously emitted in the range of about 10-14 mW to locally anneal only the magnetic films on the guide groove. This treatment degraded the magnetic property of the magnetic films on the guide groove and prevented a magnetic wall energy from being accumulated on this portion. Of the area thus locally annealed by changing the laser power, an optimum point was selected in view of a jittering value and recording/reproduction measurement was performed. Further, the selection of an optimum value of the laser power was performed while varying the power in the range of about 2-8 mW during recording and in the range of about 1-4 mW during reproduction. In this example, the optimum values were 12.4 mW for annealing power, 5.0 mW for recording power, and 2.4 mW for reproducing power.

Hence, these optimum conditions were used to measure a difference in jittering values of a reproduction signal while changing recording patterns including a recording mark length and a repetition rule thereof and the recording/erasing state of both tracks adjacent to a measured track. As a result, it was found that highly stable and preferable jittering values of 3.7-3.9 ns were obtained in any conditions and were hardly affected by a demagnetizing field, a floating magnetic field, and so on.

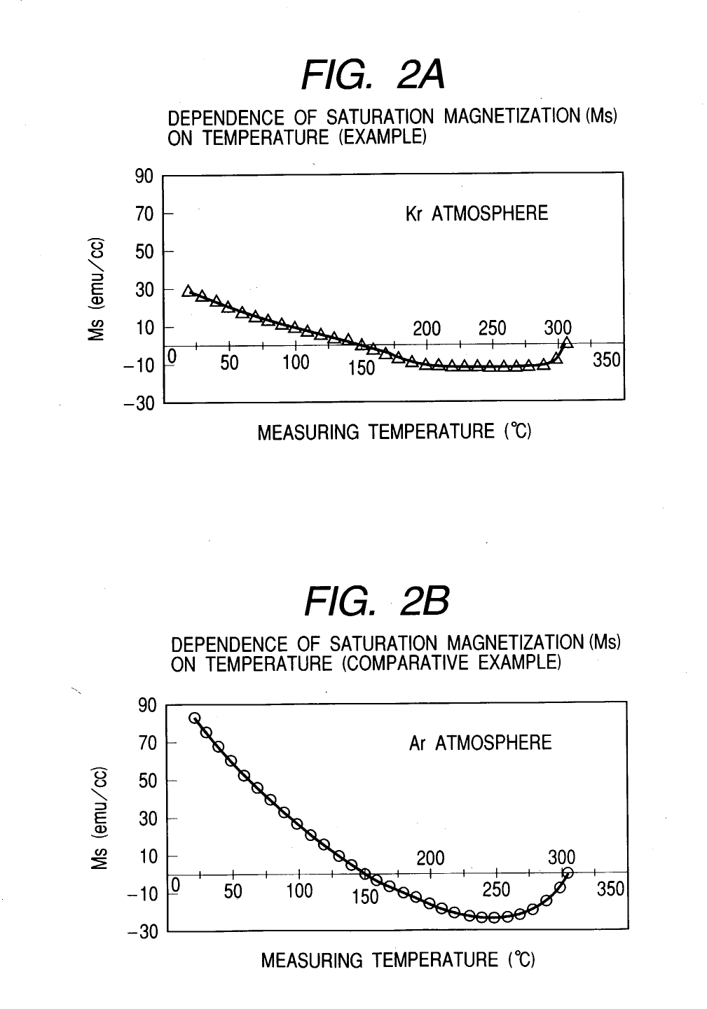

Meanwhile, saturation magnetization M_{S} on the reproduction layer of the present example was measured using another sample with a glass substrate. The film-forming conditions were the same as those of the above-described sample for evaluating the dynamic characteristic with the except that the film thickness was set at 100 nm. Further, in order to avoid the influence of oxidation, nitridation, and so on, the sample was prepared in such a configuration that Si films with a thickness of 10 nm were provided on both sides of the reproduction layer and both sides thereof were further interposed between SiN protective films of 30 nm. As to the sample thus prepared, the dependence of the saturation magnetization M_{S} on temperature was measured by a vibration specimen type magnetometer VSM in an atmosphere of He gas. The results are shown in FIG. 2A.

### COMPARATIVE EXAMPLE

As a comparative example, a sample was prepared by following the same procedure as that of above Example with the exception that when the reproduction layer was formed, the sputtering was performed using Ar gas instead of Kr gas, and the dynamic characteristic of the thus prepared sample was evaluated. As a result, the sample of this comparative example provided preferred jittering values when a monotone pattern was recorded on a single track. However, when the repetition rule of a recording mark was changed for a random pattern and the like and the recording/erasing state of adjacent tracks was changed, the jittering value fluctuated, thus failing to permit a stable operation.

Further, as with above Example, a sample was separately prepared for measuring the dependence of the saturation magnetization M_{S} on temperature and measurement was performed. The results are shown in FIG. 2B.

It is seen from the results of FIGS. 2A and 2B that even in the case of a magnetic film having substantially the same Curie temperature and magnetically compensated temperature, the dependence of the saturation magnetization M_{S} on temperature was reduced by forming the film by sputtering using Kr gas. This reduction leads to a stable reproducing operation.

The above explanation discussed the embodiment of the present invention. In addition to Kr gas, Xe gas may be used for forming the reproduction layer. Moreover, the magneto-optical recording medium of the present invention is reproduced not only by detecting a change made by a magneto-optical effect on a plane of polarization but also by detecting another change made by the movement of a domain wall.

What is claimed is:

1. A magneto-optical recording medium, comprising:
a substrate; and
a magnetic film formed on the substrate and comprising an amorphous rare earth-transition metal alloy, the magnetic film including at least a reproduction layer having a moving domain wall, a recording layer for storing an information, and a switching layer provided between the reproduction layer and the recording layer and having a lower Curie temperature than Curie temperatures of the reproduction layer and the recording layer,
wherein the reproduction layer, the switching layer, and the recording layer are magnetic films each comprising an amorphous rare earth-transition metal alloy, and the reproduction layer is formed by sputtering using a processing gas comprising Kr or Xe as a main component.

2. The magneto-optical recording medium according to claim 1, which has a recording track, wherein coupling made by exchange interaction in a film surface direction of the reproduction layer, the switching layer, and the recording layer is broken or reduced on both sides of the recording track.

3. A method of producing a magneto-optical recording medium, comprising the steps of:
forming a reproduction layer having a movable domain wall on a substrate by sputtering using a processing gas comprising Kr or Xe as a main component, the reproduction layer being composed of an amorphous rare earth-transition metal alloy; and
forming a switching layer and a recording layer each composed of an amorphous rare earth-transition metal alloy on the reproduction layer by sputtering,
wherein the switching layer has a lower Curie temperature than Curie temperatures of the reproduction layer and the recording layer, and the reproduction layer has a smaller domain wall coercive force than domain wall coercive forces of the switching layer and the recording layer.
